(19) United States
(12) Patent Application Publication
(10) Pub. No.: US 2007/0224349 A1
(43) Pub. Date: Sep. 27, 2007

(54) Wear-Resistant Coating and Method for Producing Same

(75) Inventors: Tim Matthias Hosenfeldt, Ebern (DE); Karl-Ludwig Grell, Aurachtal (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/574,274

(22) PCT Filed: Jul. 19, 2005
(86) PCT No.: PCT/EP05/07829

§ 371 Date: Apr. 12, 2007

(30) Foreign Application Priority Data
Aug. 26, 2004 (DE) 102004041235.9

(51) Int. Cl. C23C 8/00; B32B 9/00

(52) U.S. Cl. 427/249.1; 428/688

(57) ABSTRACT

A method for producing a wear resistant coating as well as a wear resistant coating is provided, which is applied to predetermined surfaces of machine parts (1) that are exposed to wear by friction, in particular for internal combustion engines. The coating is made of at least one tetrahedral amorphic carbon layer (4) that is devoid of hydrogen or practically devoid of hydrogen, with the layer being applied to the predetermined surface (2) of the machine part (1) and including sp² and sp³ hybirdised carbon for reducing the friction and for increasing the wear-resistance of the predetermined surface of the machine part.

### BACKGROUND

The present invention relates to a wear-resistant coating on predetermined surfaces of machine parts that are exposed to wear due to friction and to a method for producing such a wear-resistant coating, especially for machine parts in internal combustion engines.

Although it can be applied to any machine parts, the present invention and also the objective on which it is based will be explained in more detail with reference to machine parts for internal combustion engines, especially with reference to valve-train components, such as, for example, cup tappets.

Cam tappet devices are known, which are installed, for example, in motor vehicle engines with reciprocating pistons that have air intake and air exhaust valves, which open and close in phase or in sync with the rotation of the crankshaft. A valve-train mechanism is used for transferring the movement of the cam attached to the camshaft to the valves, when the camshaft rotates together with the crankshaft of the engine. Here, the cam of the camshaft is in frictional contact with a running surface of the associated cup tappet.

In general, modern valve-train components, for example, cup and pump tappets, are subject to increasing demands in terms of wear resistance and resource protection. The causes for the requirement of increased wear resistance lie in the ever-increasing loads and stresses on the tribological system comprised of control cams and tappets. Here, the causes lie in new motor designs, for example, gasoline and diesel direct-injection systems, with constantly increasing injection pressures, an increasing percentage of abrasive particles in the lubricant, lack of oil supply to the friction partners, which leads to an increased percentage of mixed friction, and the increasing use of tribologically unfavorable steel cams for reducing cost and mass. An important contribution to resource protection is the reduction of friction losses in the valve train, with resulting fuel savings and simultaneous increase in the service life of the entire valve train. To reduce the friction losses effectively, it is necessary to reduce the friction moment in the entire rotational speed range, i.e., to shift the Stribeck curve downward as a whole.

It is known to construct such cup tappets as light-metal tappets for the valve control of an internal combustion engine, which has a base cup body and a steel plate with a hardened surface placed on the contact surface for the control cams of the valve control.

A disadvantage in this approach has been shown, however, in that such cup tappets are exposed under operation to relatively large temperature fluctuations of −30° C. for a cold start up to about 130° C. when the internal combustion engine is running. Here, the possibly different heat expansion of the materials that are used is problematic. The steel plate placed in a light-metal tappet as a wear-resistant insert does have good wear properties, but it tends to detach under corresponding thermal loading. The thermal capacity is therefore limited. Another application-specific disadvantage consists in that the installation space in the form of a relatively wide edge is lost as a functional surface or as a cam contact surface, which is contacted by the control cam of the valve control.

According to one approach of the state of the art, it is also known to provide running surfaces of machine parts exposed to frictional wear with wear-protective layers, which, according to the application, preferably consist of electroplated metals or from metals and/or metal alloys deposited with a thermal spraying method, if necessary with mechanically resistant material additives.

In this approach, however, it has been shown to be disadvantageous that thermally sprayed metal layers have a relatively weak strength and it is therefore known to improve the strength to remelt the metal layers after deposition through, for example, plasma rays, laser rays, electron rays, or through an electric arc, such that the sprayed materials mix and alloy with the molten base material in the surface area in a molten flow. In secondary alloys, however, inhomogeneous zones of different composition are produced, in which both the base material and also the layer material can predominate. If the base material percentage is too high, the wear of the layer is then too high and if the base material percentage is low there is the risk of forming macro cracks in various layer combinations, so that such layers cannot be used. In such a case, frictional loads can cause an undesired adherence wear on the layers.

The approach of carbonitriding and/or nitrocarburizing the running surface of the cup tappet by a thermo-chemical process is further known to the applicant. In this approach, however, it has been shown to be disadvantageous that a satisfactory friction coefficient is not reached and wear resistance that is too low is produced.

It is further known to the applicant to coat the running surface of the tappet with a manganese phosphate layer or a sliding coating. Here, satisfactory friction coefficients and wear resistance values are also not achieved. In addition, such materials place an unnecessary burden on the environment. The same applies for electroplated layers, which can also be deposited onto the running surfaces.

Furthermore, in the state of the art, hard metals and high-speed steels (ASP 23) are known as coating materials, which feature, however, in addition to an unsatisfactory friction coefficient and an unsatisfactory wear resistance, also a disadvantageously high mass. Furthermore, producing these materials is associated with a high production expense.

In addition, layers produced, for example, by means of a PVD or PA(CVD) method, such as TiN, CrN, (Ti, Al)N, are known to the applicant. In this approach, it has been shown to be disadvantageous that these layers result in high wear on the counter body.

From U.S. Pat. No. 5,237,967, carbon-based PVD and (PA)CVD layers with 20 to 60 atomic % hydrogen in the cover layer are known, so-called metal-containing hydrogenated carbon layers (Me-C:H) and amorphous hydrogenated carbon layers (a-C:H). These layers have a wear resistance that is too low, however, and low chemical stability. Furthermore, they have too high of a fluid friction coefficient, and guarantee no friction reduction in the oil-lubricated state.

### SUMMARY

Thus, the present invention is based on the objective of creating a coating and also a production method for such a coating, which eliminate the disadvantages named above and which in particular reduce the friction moment in the entire area of use and increase the service life of the coated machine part as well as the counter body.

According to the invention, this objective is met for a device through a wear-resistant coating with the features of claim 1, and for a method by a method with the features of claim 13.

The invention is based on the idea that the wear-resistant coating is comprised of at least one practically hydrogen-free tetrahedral amorphous carbon layer made from sp² and sp³ hybridized carbon applied onto a predetermined surface of the machine part for reducing the friction and for increasing the wear resistance of the predetermined surface of the machine part. The layer system here is comprised of more than 97 atomic percent carbon, for example, wherein the hydrogen percentage may equal a maximum of 3 atomic percent.

Thus, the present invention has the advantage relative to the known approaches according to the state of the art that the friction moment is considerably reduced by the hydrogen-free carbon layer, especially in the oil-lubricated state. Furthermore, the surface state is considerably homogenized and stabilized. In addition, the wear resistance is increased based on the percentage of sp³ bonds. Through the excellent tribological properties, lubricants that are more economical and have a lower viscosity and that feature lower internal friction values can be used. In addition, oil-change intervals can be increased and thus it has a more customer-friendly construction. Through the possibility of also using hydraulic oil, diesel fuel, water to gasoline as lubricants, completely new fields of application are offered in the foods industry and hydraulic and other media-lubricated applications.

Advantageous constructions and improvements of the wear-resistant coating specified in claim 1 and also the method specified in claim 13 are found in the dependent claims.

According to a preferred improvement, the coating is comprised of at least 97 atomic % hybridized carbon, wherein the percentage of sp³ hybridized carbon in the tetrahedral amorphous carbon layer equals more than 50%. Through such a high percentage of sp³ bonds, high hardness values and very low dry-friction values are achieved.

According to another preferred embodiment, the percentage of hydrogen in the tetrahedral amorphous carbon layer equals a maximum of 3 atomic %. Such a low percentage of hydrogen is advantageous, because the hydrogen would enter into new bonds, e.g., with the hydrogen of a lubricant, in an undesired way. Such bonds are thus reduced and a constant layer property is guaranteed in operation. Furthermore, through a practically hydrogen-free carbon layer, the friction in the oil-lubricated state is considerably reduced due to the known effect of the homogenization and stabilization of the surface state.

According to another preferred improvement, the tetrahedral amorphous carbon layer has hardness values of 30 to 95 GPa, an elastic modulus in the range from 300 to 820 GPa, and a ratio of hardness to elastic modulus of at least 0.15. Such hardness values contribute to an increased wear resistance, which is preferably guaranteed during the entire service life of the engine.

Preferably, the tetrahedral amorphous carbon layer has a thermal stability temperature of or oxidation resistance up to approximately 600° C. Relative to hydrogen-containing carbon layers, which have, for example, a thermal stability up to only 350° C., thus an increased thermal stability is reached, whereby a significantly larger field of use is produced.

Advantageously, the hydrogen-free tetrahedral amorphous carbon layer has a thickness of approximately 0.1 μm to 4.0 μm, in particular 2.0 μm. The corresponding thickness of the carbon layer is adaptable to the appropriate requirements or the appropriate customer desires.

According to another preferred embodiment, between the predetermined area of the machine part and the tetrahedral amorphous carbon layer there is at least one support layer and/or at least one bonding-agent layer, which is constructed, for example, using a PVD method with a metal-bearing, for example, tungsten-comprising, carbon layer, a layer with carbides and/or nitrides of the transition metals, by means of a heat treatment as a case-hardened, carbonitrided, or nitrocarburized layer, by means of a thermo-chemical method as a nitrided or borated layer, and/or, for example, by means of an electroplating method as a layer with chromium. Preferably, the one or more support layers and/or bonding-agent layers each has a thickness of 0.1 μm to 4.0 μm, wherein the thickness is to be adapted, in turn, to the corresponding requirements or to the customer desires.

For example, the predetermined surface of the machine part is comprised of 16MnCr5, C45, 100Cr6, 31CrMoV9, 80Cr2, or the like.

Advantageous uses of the coatings according to the invention represent a counter-contact layer on a counter surface of a cup tappet, finger or rocker lever in internal combustion engines, the cam contact surface or the cam contact surface and/or the cup shroud of the cup tappet, predetermined surfaces of valve-train components, in particular, mechanical and hydraulic cup tappets, hydraulic support and insert elements, roller-bearing components, control pistons, throw-out bearings, piston pins, bearing bushings, linear guides, or the like. Here, advantageously only certain surfaces of the individual machine parts or the entire surfaces of the machine parts are constructed with a coating according to the invention.

The individual layers are preferably deposited by means of a PVD method. Here, preferably no thermal and/or mechanical finishing is performed on the deposited carbon layer, if friction reduction is desired. Mechanical finishing work, for example, polishing and/or brushing of the deposited carbon layer, is preferably performed when protection from frictional wear is desired. The coating process is preferably performed at a temperature, which equals a maximum of 160° C., and preferably 120° C.

The invention is explained in more detail below using embodiments with reference to the enclosed figures of the drawing. Shown by the figures are:

### BRIEF DESCRIPTION OF THE DRAWINGS

FIG. 1 a front view of a friction pair consisting of a cup tappet and camshaft for the operation of a valve of an internal combustion engine;

FIG. 2 a perspective view of the cup tappet from FIG. 1;

FIG. 3 a perspective view of a hydraulic support element, which is connected to a finger lever via a roller-bearing component; and

FIG. 4 a schematic cross-sectional view of a machine part with wear-resistant coating according to an embodiment of the present invention.

### DETAILED DESCRIPTION OF THE PREFERRED EMBODIMENTS

In the figures of the drawing, identical reference symbols designate identical or functionally identical components, unless stated to the contrary.

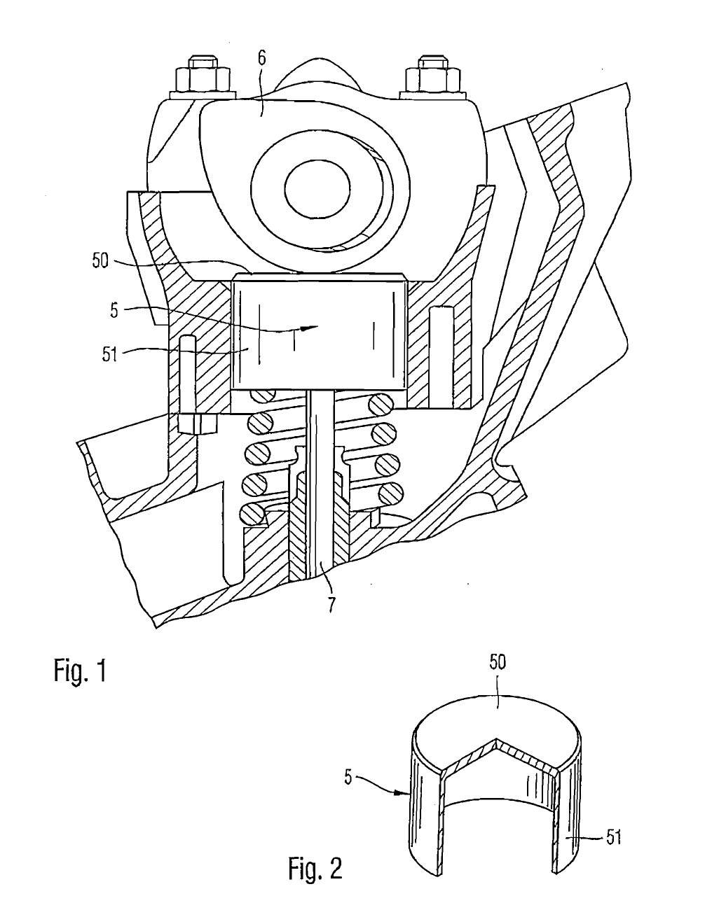

FIG. 1 illustrates a friction pair comprising a cup tappet 5 with a cam contact surface 50 and a cup shroud 51, and also a cam 6. The cup tappet 5 is shown in more detail in FIG. 2 in a perspective view, wherein it is visible that the cup shroud 51 at least partially surrounds the cam contact surface 50. The cup tappet 5 is generally connected to the shaft 7 of a valve, which opens or closes the valve through contact of the cam surface with the cam contact surface 50 of the cup tappet 5, for machine parts in internal combustion engines.

In general, modern valve-train components, for example, cup and pump tappets, are subject to high demands in terms of wear resistance and resource protection, especially on the contact surface 50.

In connection with FIG. 4, which illustrates a schematic cross-sectional view of a wear-resistant coating for a machine part 1, for example, for a cup tappet 5, according to a preferred embodiment of the present invention, an embodiment of the present invention is explained below in more detail.

The cup tappet 5 is coated with a wear-resistant coating for reducing the friction coefficient and for increasing the wear resistance in the area of the cam contact surface 50 or, if necessary, in the area of the cam contact surface 50 and the cup shroud 51. In the case of high deformation of the cup shroud 51 of the cup tappet 50 in the area of the open side, a partial coating of the cup shroud 51, an exclusive coating of the cam contact surface 50, or a later at least partial removal of the friction-resistance coating in the area of the cup shroud 51 of the cup tappet 5 can also be performed selectively.

In the present case, the assumption initially applies that the cam contact surface 50 of the cup tappet 5 is viewed as a predetermined surface 2 of the machine part. It is obvious for someone skilled in the art that any predetermined surfaces of any machine part can be coated with the coating according to the invention.

The predetermined surface 2, i.e., in the present case the cam contact surface 50 of the cup tappet 5, is preferably case-hardened or carbonitrided and tempered before a coating process.

The base body, in the present case the cam contact surface 50 of the cup tappet 5, which is comprised advantageously from an economical steel material, for example, 16MnCr5, C45, 100Cr6, 31CrMoV9, 80Cr2, or the like, is then coated with a support layer 3 and/or a bonding-agent layer 3 according to the present embodiment. The support layer 3 or the bonding-agent layer 3 can be comprised, for example, from a metal-containing carbon, for example, a compound made from tungsten and carbon, but also from other metallic materials, as well as borides, carbides, and nitrides of the transition metals. The support layer 3 and/or the bonding-agent layer 3 can be formed, for example, by heat treatment, for example, case hardening, carbonitriding, nitrocarburizing, by a thermo-chemical method, for example, nitriding, borating, by an electroplating method, for example, by applying a chromium-containing layer, or by means of a PVD method, for example, applying Me-C, carbides, and nitrides of the transition metals. For a PVD method, for example, for the sputtering or ARC technology, metals are simultaneously vaporized and introduced into the layer to be formed. Here, graphite is vaporized as a solid starting material and deposited by means of concentration through the introduction of high energy onto the predetermined surface 2 of the cup tappet 5 as a sub-crystalline layer.

At this point it should be noted that instead of one support layer 3 or one bonding-agent layer 3, several support layers 3 or several bonding-agent layers 3 or a combination of these two layers can be formed on the base body or the predetermined surface 2 of the cup tappet 5. For the case that an improvement of the bonding of the wear-resistant coating or a support surface still to be formed on the base body is desired, a layer is formed as a bonding-agent layer 3 with a thickness, for example, of 0.1 μm to 2.0 μm on the base body. For the case that the layer is to be used, however, as a support layer, i.e., as mechanical support between the base body and the wear-resistant coating still to be formed, thicknesses of, for example, 2.0 μm to 4.0 μm are advantageous. By means of the support layer, the fatigue strength should be increased, i.e., cracks and fractures of the wear-resistant coating are prevented. Such cracks could result when the cup tappet 5 bends and deforms if it contacts the cam 6 or due to different degrees of hardness, elastic moduli, deformation of the individual layers or the base body, and the wear-resistant coating. In this case, a construction of the layer 3 as a support layer 3 either alone or in combination with a suitable bonding-agent layer is to be preferred.

As shown in FIG. 4, according to the present embodiment, after the formation of the support and/or bonding-agent layer 3, a wear-resistant coating 4 is formed on this layer. The wear-resistant coating 4 is preferably comprised of a hydrogen-free or at least practically hydrogen-free tetrahedral amorphous carbon layer (ta-C layer) or several such layers 4. The amorphous carbon layer 4 is preferably comprised only of sp² and sp³ hybridized carbon, wherein advantageously more sp³ bonds than sp² bonds are provided in the amorphous carbon layer 4. In this way, the degree of hardness of the coating 4 increases to provide an increase in the wear resistance.

The hydrogen percentage in the coating 4 preferably equals a maximum of 3 atomic %, so that extreme purity is guaranteed. This is advantageous because hydrogen in the coating would enter into new bonds, for example, with the hydrogen of the lubricants. According to the present invention, through the low hydrogen percentage or through the elimination of hydrogen in the coating, a constant layer property is guaranteed over the entire service life of the machine part 1 during operation, which allows use in engines and machines in a plurality of applications.

Preferably, the hardness values of the hydrogen-free tetrahedral amorphous carbon layers 4 (ta-C layers) are set within a very wide spectrum, adapted to the appropriate application, from 30 GPa to 95 GPa (Martens hardness according to EN ISO 14577-1) in comparison to all of the other mechanically resistant material layers.

In comparison with these conditions, the previously used mechanically resistant material layers (Me-C:H, a-C:H, metal nitride mechanically resistant material layers) can cover only a hardness range from approximately 20 GPa to 40 GPa, so that the ta-C layers have significantly higher hardness values and also only those wear resistance values that are sufficient for the most loaded components. Thus, in the dome-grinding method with diamond suspension grain size (0.25 μm), the ta-C layers achieve extremely low wear rates of Vᵣ<0.5×10⁻¹⁵ m³ N m⁻¹, which corresponds accordingly to an extremely high wear resistance, because for identical measurement parameters and conditions, all of the previously used layers (Me-C:H, a-C:H, metal nitride mechanically resistant material layers) have wear rates Vᵣ greater than 0.6×10⁻¹⁵ m³ N m⁻¹ up to 50×10⁻¹⁵ m³ N m⁻¹. An important quality feature is the ratio of universal hardness [GPa] to elastic modulus [GPa]. Here, the goal is the highest possible ratio, that is, a layer with a high hardness and thus with a high wear resistance and also in the ratio a low elastic modulus, in order to transfer the smallest possible contact stresses and to introduce low loading-induced stresses into the layer system, interface, and component and thus to realize high local (fatigue) strengths.

The elastic moduli of the hydrogen-free tetrahedral amorphous carbon layers lie in the range from 300 GPa to 820 GPa. Steel has an elastic modulus of approximately 210 GPa and a-C:H layers have elastic moduli from 250 GPa to 500 GPa. In comparison with all of the other previously used layer systems and surfaces, the hydrogen-free tetrahedral amorphous carbon layers thus have clearly higher hardness-to-elasticity modulus ratios of up to 0.20 [GPa/GPa] in contrast to the best case of 0.10 to 0.15.

The hard particles, which are found increasingly in the engine applications described here between friction partners, induce high local stresses in the surfaces, which leads to local material fatigue, when the induced stresses lie over the local fatigue strength of the layer system. Therefore, layer systems are necessary, which have the highest possible fatigue strength values or hardness values as well as the highest possible percentage of elastic deformability; i.e., for the same material deformation, the greatest possible percentage of deformation springs back elastically due to a hard particle and thus the smallest possible percentage of plastic deformation or damage to the surface remains. The elastic percentage TV according to EN ISO 14577-1 “Instrumented indentation test for determining hardness and other material parameters” is used for quantitative evaluation of this quality feature. Here, the hydrogen-free tetrahedral amorphous carbon layers achieve excellent values up to 95% and can be set between 75% and 95%. In comparison with this result, hardened steel 100Cr6 (60 HRC+4 HRC) achieves approximately 30% and previously used layers achieve approximately 60% to 80%.

The tetrahedral amorphous carbon layer 4 is preferably deposited by a PVD method onto the support or bonding-agent layer 3. Here, for example, graphite is heated with a high-energy beam such that an ion beam made from carbon atoms is dissolved from the graphite and can be oriented onto the surface of the cup tappet 5 or the machine part 1. Therefore, sp² bonds and sp³ bonds are deposited onto the support or bonding-agent layer 3. Depending on the energy of the ions of the ion beam comprised of carbon atoms, which feature, for example, energies from 60 to 160 electron volts, the respective percentage of sp² bonds and sp³ bonds can be controlled. An increase of the energy of the ions of the ion beam comprised of carbon atoms increases the percentage of sp³ bonds. Thus, overall an amorphous coating with small crystalline areas, which has a high wear resistance and low friction coefficient, is produced.

When the tetrahedral amorphous carbon layer 4 is deposited, the base body to be coated is rotated in a deposition chamber, for example, such that for each rotation cycle, a layer deposit of sp² and sp³ hybridized carbon is formed on the base body or the support or bonding-agent layer 3.

The thickness of the amorphous carbon layer 4 can equal between 0.1 μm and 4.0 μm, in particular 2.0 μm. If the amorphous carbon layer 4 is deposited on a layer with good surface qualities, then, for example, a thickness of 0.1 μm to 2.0 μm is sufficient, because the carbon coating 4 is used predominantly for reducing the friction coefficient. In contrast, if the carbon coating 4 is deposited on rather rough surfaces, then the thickness of the coating 4 preferably equals between approximately 2.0 μm and 4.0 μm, because the coating 4 is here used predominantly for increasing the wear resistance. The hardness values of the coating 4 preferably lie between 60 and 95 GPa, in order to provide significantly higher wear resistance values in comparison with the previously used mechanically resistant material layers (a-C:H; Me-C:H; metal nitride layers).

For achieving the best tribo-mechanical properties, i.e., to minimize the friction of the system, to increase the static and cyclical strength of the described component, and also to protect the uncoated friction partner from wear by coating one friction partner, it is necessary to limit the average roughness Rₐ after the coating to a maximum of 0.035 μm. If the average roughness Rₐ after the coating equals greater than 0.035 μm, then subsequent mechanical finishing work is to be performed on the functional surface, i.e., the surface of the hydrogen-free tetrahedral amorphous carbon layer, through, for example, polishing and/or brushing.

To achieve the lowest possible tendency for adhesion to the metallic counter body, i.e., in the present case the cam 6; a high abrasive wear resistance; a high chemical resistance, even in contact with oil; high mechanical strengths; and large hardness/elastic modulus ratios, the carbon layer advantageously has a maximum hydrogen percentage of 3 atomic %, as already explained above. Thus, a hydrogen-free or at least practically hydrogen-free tetrahedral amorphous carbon layer is deposited, which feature tribophobic surfaces with polarizing properties supporting the lubrication and friction reduction relative to conventional hydrogen-containing carbon layers in terms of the wear. Therefore, the friction is reduced both in dry friction contact with metallic materials and also in the lubricated state. As the lubricant, for certain applications, fluids with an extremely low viscosity up to that of water or gasoline can be used.

In the oscillating friction contact with a steel ball made from 100Cr⁶ (travel 1.0 mm, oscillating frequency 25 Hz, ball diameter 10 mm, normal force of the ball on the coated surface 20 N), the friction in dry friction contact decreases by more than 80% and with motor oil by more than 10%. These unique tribological properties have the effect that in the valve train friction reductions of 6% to 28% result according to the oil temperature and relative speed of the friction partners due to the coating of the cup base surface. The special difference from the previously used layer systems is that a significant reduction of friction in the rotational speed range from 2000 rpm to 7000 rpm is produced, so that a potential for reducing friction in the valve train that previously could not be realized and thus a potential for fuel savings or resource protection is produced, which remain preferably over the entire service life of the engine due to the extremely high wear resistance.

In addition, the ta-C layers 4 offer an increased oxidation resistance up to approximately 600° C., higher corrosion resistance, lower electrical conductivity, and higher chemical stability, which guarantees constant quality during use, in comparison with layers according to the state of the art. Due to the extremely high wear resistance, only small layer thicknesses are necessary, whereby the risk in use of Hertzian stress that the maximum comparison stress lies in the interface can be avoided. In addition, absolutely no excess measures are necessary and the deposition times and thus deposition costs or coating costs can be reduced considerably.

In addition to the wear protection of the coated body, the counter body is also protected due to the excellent tribological layer properties of the carbon layer or layers 4. Through the use of the coating, economical materials can be used as the substructure. Then, in the sense of lightweight construction and cost savings, iron-carbon alloys can also be realized as the counter body for the camshaft or the cam 6, for example. In addition, low viscosity and low additive oil can be used, whereby minimal lubrication or increased oil change intervals can be realized.

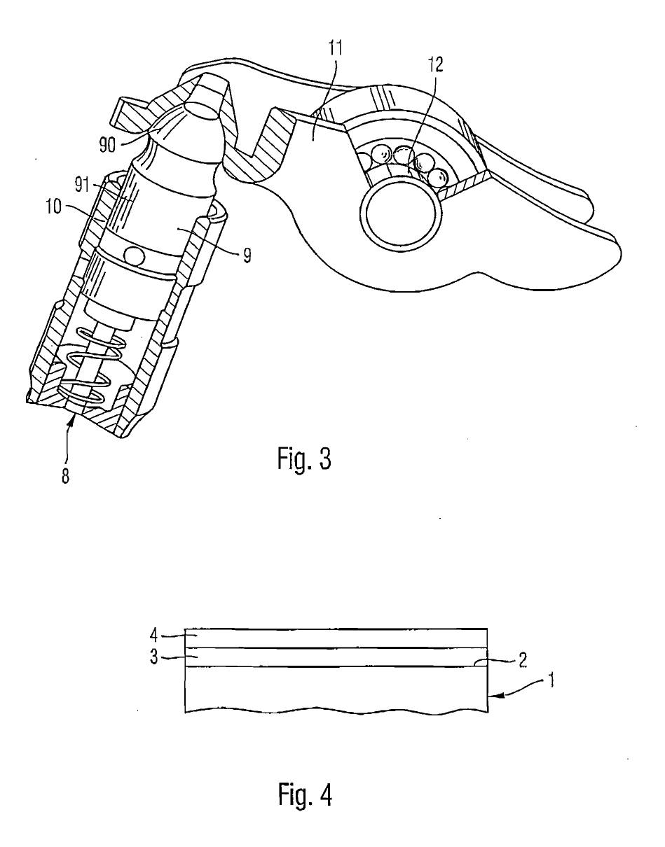

Below, another advantageous use of the coating according to the invention is explained in more detail. FIG. 3 illustrates a perspective view of a hydraulic support element 8, which has a piston 9 and a housing 10. The hydraulic support element 8 is coupled with a finger lever 11, wherein the finger lever 11 is supported rotatably by a roller bearing 12. As is further visible in FIG. 3, the piston 9 has a contact area 90 between the piston 9 and the finger lever 11. Furthermore, the piston 9 has a contact area 91 between the piston 9 and the housing 10. For reducing the wear in the contact area 90 between the piston 9 and the finger lever 11, the contact area 90 is also coated with a hydrogen-free or practically hydrogen-free tetrahedral amorphous carbon layer 4 according to the invention and comprised of sp² bonds and sp³ bonds with the intermediate connection, for example, of a support layer and/or a bonding-agent layer. The friction-resistant coating here corresponds to the coating 3, 4 explained in the first embodiment according to FIGS. 1, 2.

Furthermore, the contact area 91 between the piston 9 and the housing 10 can also be coated with such a coating 3, 4 according to the application and production technology. In this way, the entire service life of the shown tribological system is increased, whereby failure of the individual machine parts during operation is reduced and thus total costs can be saved.

Furthermore, certain roller-bearing components of the roller bearing 12, for example, the roller body, the inner and outer rings of the roller bearing 12, the roller-bearing cage, the axial disks, or the like can also be coated with a hydrogen-free or practically hydrogen-free tetrahedral amorphous carbon layer 4 described above and comprised of sp² bonds and sp³ bonds with the intermediate connection, for example, of a support layer and/or bonding-agent layer 3 also for increasing the wear resistance and for reducing friction.

The layer system described above is obviously also suitable for other structural and functional units, for example, support and insert elements, roller-bearing components, throw-out bearings, piston pins, bearing bushings, control pistons for fuel injectors, for example, in the motor industry, linear guides, and other mechanically and tribologically highly stressed parts.

At this point it should be noted that the amorphous carbon layer 4 can also be deposited directly on the base body of the machine part to be coated, without a support layer 3 or bonding-agent layer 3 being applied in-between.

Thus, the present invention creates a wear-resistant coating and also a method for producing such a wear-resistant coating, whereby the wear resistance of machine parts exposed to wear due to friction is increased and friction moments that are too high between these machine parts and corresponding counter bodies are prevented. Through the approximately 0.1 μm to 4.0 μm thick coating 4 or 3, 4, the dimensions and surface roughness values remain practically unchanged, wherein nevertheless the surface becomes homogeneous reactively. The tribological properties of the layer are improved and the mechanical demands are divided with the base body, which can be produced on economical steels due to the stated problem and the low coating temperature, which is less than 160° C. Therefore, common and economical production technologies can be used.

The proposed hydrogen-free carbon layers reduce the friction in the oil-lubricated state under consideration of the recognized effect of homogenizing the surface state. Friction moments that were lower by approximately 20% with steel or cast iron as the friction partner were measured in the oil-lubricated state, whereby a significant contribution to the power increase and resource protection is produced. Due to the excellent tribological properties, more economical and also low viscosity lubricants can be used, which exhibit lower internal friction. Furthermore, oil change intervals can be increased in a customer-friendly way.

In addition, the proposed ta-C layer has a significantly higher thermal stability of approximately 600° C. relative to 350° for hydrogen-containing carbon layers, whereby a larger field of use is produced. Through the possibility of also using hydraulic oil, diesel fuel, water, up to gasoline as the lubricant, new fields of use open up in the foods industry and in hydraulic and other media-lubricated applications.

Although the present invention was described above with reference to preferred embodiments, it is not limited to these, but instead can be modified in many ways.

### REFERENCE SYMBOLS

1 Machine Part
2 Predetermined Surface of Machine Part
3 Support layer/bonding-agent layer
4 Tetrahedral Amorphous Carbon Layer
5 Cup Tappet
6 Cam
7 Valve Shaft
8 Hydraulic Support Element
9 Piston
10 Housing
11 Finger Lever
12 Roller Bearing
50 Cam Contact Surface
51 Cup Shroud
90 Contact area between piston and dragging lever
91 Contact area between piston and housing

1. Wear-resistant coating for a predetermined surface of a machine part exposed to wear due to friction, comprising at least one hydrogen-free or practically hydrogen-free tetrahedral amorphous carbon layer deposited on the predetermined surface of the machine part and comprised of sp² and sp³ hybridized carbon for reducing friction and increasing the wear resistance of the predetermined surface of the machine part.

2. Wear-resistant coating according to claim 1, wherein the coating comprises at least 97 atomic % hybridized carbon, wherein a percentage of sp² hybridized carbon in the hybridized carbon equals at least 50%.

3. Wear-resistant coating according to claim 1, wherein a percentage of hydrogen in the tetrahedral amorphous carbon layer equals a maximum of 1 atomic %.

4. Wear-resistant coating according to claim 1, wherein the tetrahedral amorphous carbon layer has hardness values of 30 to 95 GPa, an elastic modulus in a range from 300 GPa to 820 GPa, and a ratio of a hardness modulus of at least 0.15.

5. Wear-resistant coating according to claim 1, wherein the tetrahedral amorphous carbon layer has a thermal stability temperature of or an oxidation resistance up to approximately 600° C.

6. Wear-resistant coating according to claim 1, wherein the tetrahedral amorphous carbon layer has a thickness of approximately 0.1 μm to 4.0 μm.

7. Wear-resistant coating according to claim 1, wherein between the predetermined surface of the machine part and the tetrahedral amorphous carbon layer there is at least one support layer and/or at least one bonding-agent layer, which is formed by a PVD method as a metal-containing carbon layer comprising, tungsten, as a layer with carbides and/or nitrides of transition metals, as a layer that has been case-hardened, carbonitrided, or nitrocarburized by a heat treatment, by a thermo-chemical method as a nitrided or borated layer, or by an electroplating method as a layer with chromium as a chromium nitride layer.

8. Wear-resistant coating according to claim 7, wherein the one or more support layers and/or the one or more bonding-agent layers have a thickness of approximately 0.1 μm to 4.0 μm.

9. Wear-resistant coating according to claim 1, wherein the predetermined surface of the machine part is comprised of 16MnCr5, C45, 100Cr6, 31CrMoV9, 80Cr2.

10. The wear-resistant coating according to claim 1, wherein the coating comprises a counter-contact layer on a machine part constructed as a cup tappet, finger or rocker lever.

11. The wear-resistant coating according to claim 10, wherein a cam contact surface of the cup tappet or the cam contact surface and a cup shroud of the cup tappet is constructed completely or at least partially with the wear-resistant coating.

12. The coating according to claim 1, wherein the predetermined surface comprises a surface on valve-train components, mechanical and hydraulic cup tappets, hydraulic support and insert elements, roller bearing components, control pistons, especially for fuel injectors in the motor industry, throw-out bearings, piston pins, bearing bushings, or linear guides.

13. Method for producing a wear-resistant coating on predetermined surfaces of a machine part exposed to wear due to friction with the following processing step: depositing at least one hydrogen-free or practically hydrogen-free tetrahedral amorphous carbon layer made from sp² and sp³ hybridized carbon on the predetermined surface of the machine part for reducing friction and for increasing wear resistance of the predetermined surface.

14. Method according to claim 13, wherein the depositing is carried out by a PVD method.

15. Method according to claim 13, wherein the tetrahedral amorphous carbon layer is formed with a thickness of approximately 0.1 μm to 4.0 μm.

16. Method according to claim 13 wherein the coating process is performed at a temperature, which equals a maximum of 160° C.

17. Method according to claim 13, wherein no thermal and/or mechanical finishing work is performed on the deposited amorphous carbon layer when friction reduction is desired.

18. Method according to claim 13, wherein mechanical finishing work including polishing and/or brushing, is performed on the deposited amorphous carbon layer, when protection from wear due to friction is desired.

19. Method according to claim 13, wherein the predetermined surface of the machine part is produced from 16MnCr5, C45, 100Cr6, 31CrMoV9, 80Cr2.

20. Method according to claim 13, wherein before the deposition, the predetermined surface of the machine part is case-hardened and/or carbonitrided and tempered.

21. Method according to claim 13, wherein prior to the depositing step applying at least one support layer and/or at least one bonding-agent layer onto the predetermined surface, which is formed by a PVD method as a metal-containing carbon layer comprising, for example, tungsten, as a layer with carbides and/or nitrides of the transition metals, by a heat treatment as a case-hardened, carbonitrided, or nitrocarburized layer, by a thermo-chemical method as a nitrided or borated layer, by an electroplating method as a layer with chromium as a chromium nitride layer.

22. Method according to claim 21, wherein the at least one support layer and/or the at least one bonding-agent layer is formed with a thickness of approximately 0.1 μm to 4.0 μm.

23. Method according claim 1, wherein the coating is formed from at least 97 atomic % hybridized carbon, wherein the percentage of sp³ hybridized carbon in the hybridized carbon equals at least 50%.
